(19) United States
(12) Patent Application Publication
(10) Pub. No.: US 2026/0362060 A1
(43) Pub. Date: Nov. 12, 2026

(54) DUAL MOTOR DIPOLE SPEAKER

(71) Applicant: Apple Inc., Cupertino, CA (US)

(72) Inventors: Claudio NOTARANGELO, San Francisco, CA (US); Christopher WILK, Los Gatos, CA (US); Marco BARATELLI, San Francisco, CA (US)

(21) Appl. No.: 19/559,840

(22) Filed: Mar. 6, 2026

Related U.S. Application Data
(60) Provisional application No. 63/802,558, filed on May 8, 2025.

(51) Int. Cl. H04R 9/06; H04R 1/10; H04R 7/04; H04R 9/02; H04R 9/04; H04R 1/02

(52) U.S. Cl. CPC H04R 9/063; H04R 1/1008; H04R 1/105; H04R 7/04; H04R 9/025; H04R 9/046; H04R 1/028; H04R 2499/15

(57) ABSTRACT

A speaker for an electronic device includes multiple motors, with each motor designed to drive a sound-generating component to produce an acoustic output. Speakers with multiple sound-generating components may function as a dipole speaker. In this regard, the sound-generating components may operate by force cancelling the force from another sound-generating component while providing the acoustic output.

### CROSS REFERENCE TO RELATED APPLICATIONS

The present application claims the benefit of U.S. Provisional Application No. 63/802,558, entitled “DUAL MOTOR DIPOLE SPEAKER”, filed May 8, 2025, the entirety of which is incorporated herein for reference.

### TECHNICAL FIELD

This application is directed to a speakers, and more particularly, to dual motor speakers for electronic devices.

### BACKGROUND

Speakers may be provided in electronic devices to provide an acoustic output. Speakers may be integrated with electronic devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of a speaker, in accordance with aspects of the present disclosure.

FIG. 2 illustrates a partial cross sectional view of the speaker shown in FIG. 1, taken along line 2-2, showing additional features of the speaker, in accordance with aspects of the present disclosure.

FIG. 3 illustrates a partial cross sectional view of the speaker shown in FIG. 1, taken along line 3-3, showing additional features of the speaker, in accordance with aspects of the present disclosure.

FIG. 4 illustrates an aerial view of a speaker, showing several components of the speaker, in accordance with aspects of the present disclosure.

FIGS. 5A and 5B illustrate cross sectional views of the sound-generating components of a speaker, showing exemplary movement of the sound generating components during operation, in accordance with aspects of the present disclosure.

FIG. 6 illustrates a perspective view of an assembly with a speaker, in accordance with aspects of the present disclosure.

FIG. 7 illustrates an aerial view of an electronic device with multiple speakers, in accordance with aspects of the present disclosure.

FIG. 8 illustrates a side view of an electronic device with a speaker, in accordance with aspects of the present disclosure.

FIGS. 9 and 10 illustrate partial cross sectional views of a speaker, showing additional orientations of magnets of the speaker, in accordance with aspects of the present disclosure.

FIG. 11 illustrates a block diagram of an electronic device, in accordance with aspects of the present disclosure.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to speakers designed to maximize low frequency output while minimizing distortion and inductance. In one or more implementations, speakers described herein may take the form of a dipole speaker with multiple motors and multiple sound-generating components. For example, speakers described herein may include a first motor and a second motor. One or more of the motors may include magnets and/or voice coils, with the voice coils formed by a wire (e.g., a single wire) that is wrapped around the magnets. The magnets are oriented such that electrical current passing through a first voice coil causes the magnets of the first motor to be magnetically attracted to an electromagnetic field generated by the first voice coil, while the electrical current passing through a second voice coil causes the magnets of the second motor to be magnetically repelled by an electromagnetic field generated by the second voice coil. When a sound-generating component (e.g., diaphragm) is driven by the first voice coil in a forward direction, a sound-generating component is substantially simultaneously driven by the second voice coil in a reverse direction, thus creating a dipole speaker effect. As a result, the sound-generating components provide a force-cancelling effect in which one sound-generating component cancels the force of another sound-generating component, and vice versa. Beneficially, a user’s ear, for example, is less susceptible to forces from the sound-generating components.

Additionally, speakers described herein with multiple sound-generating components include motors that are covered by respective sound-generating components. Based in part on this design layout, additional space may be available to displace air when the motor components are placed around the outer perimeter of the loudspeaker (e.g., underneath the membrane roll). Air displacement can then be maximized by stacking multiple sound-generating components (e.g., diaphragms) on top of each other.

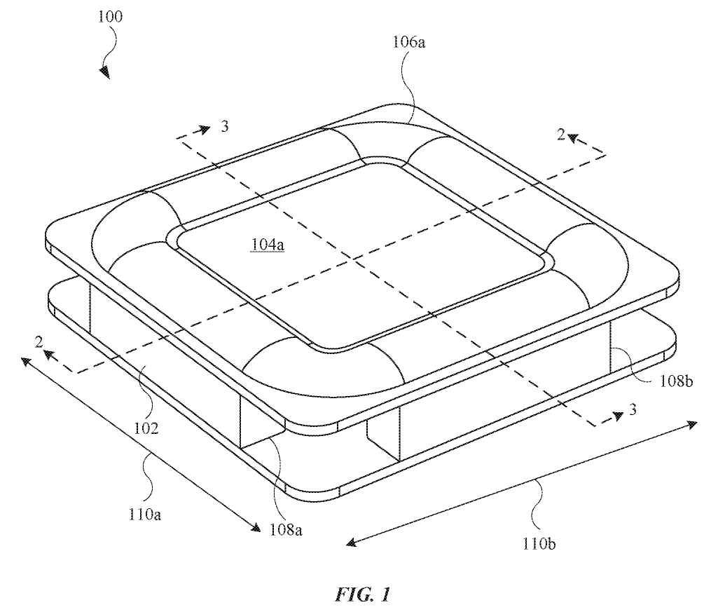

These and other embodiments are discussed below with reference to FIGS. 1–12. However, those skilled in the art will readily appreciate that the detailed description given herein with respect to these Figures is for explanatory purposes only and should not be construed as limiting.

FIG. 1 illustrates a perspective view of a speaker 100, in accordance with aspects of the present disclosure. The speaker 100 (representative of other speakers shown and/or described herein) is designed to generate an acoustic output (e.g., soundwaves) in the form of audible sound. The speaker 100 may function as an audio transducer to convert electrical signals to an acoustic output using multiple sound-generating components. Further, the speaker 100 may be integrated with electronic devices, including wearable devices (e.g., head mountable devices including mixed reality devices, smart watches, etc.), mobile wireless communication devices (e.g., smartphones, tablet computing devices), and/or headphones (e.g., over-the-ear headphones, earbuds), as non-limiting examples.

As shown, the speaker 100 may include a housing 102 (e.g., speaker housing) designed to carry several components of the speaker 100, which will be shown and described in further detail below. Also, the speaker 100 may further include a sound-generating component 104a. In one or more implementations, the sound-generating component 104a takes the form of a diaphragm or a membrane. In this regard, the sound-generating component 104a may be driven (e.g., oscillate) to generate an acoustic output in the form of audible sound. The speaker 100 may further include a surround 106a that connects the sound-generating component. The surround 106a may facilitate oscillation/movement of the sound-generating component 104a relative to the housing 102. The sound-generating component 104a and the surround 106a may be representative of an additional sound-generating component and a surround, respectively, which will be shown and described below.

Also, the housing 102 may include several openings. For example, the housing 102 may include an opening 108a and an opening 108b, each representative of an additional opening of the housing 102. The openings 108a and 108b may provide for benefits such as a pathway for acoustical output and/or pressure equalization between the environment outside of and within the speaker 100.

The speaker 100 may further include a dimension 110a and a dimension 110b. In one or more implementations, the dimension 110a is the same as, or at least substantially similar to, the dimension 110b, and the speaker 100 may take the form of a square speaker. However, in one or more implementations, the dimension 110a is different than (e.g., greater than, less than) the dimension 110b, and the speaker 100 may take the form of a rectangular speaker. In this regard, the aspect of the speaker 100 may be adjusted based on different considerations such as size and acoustic output.

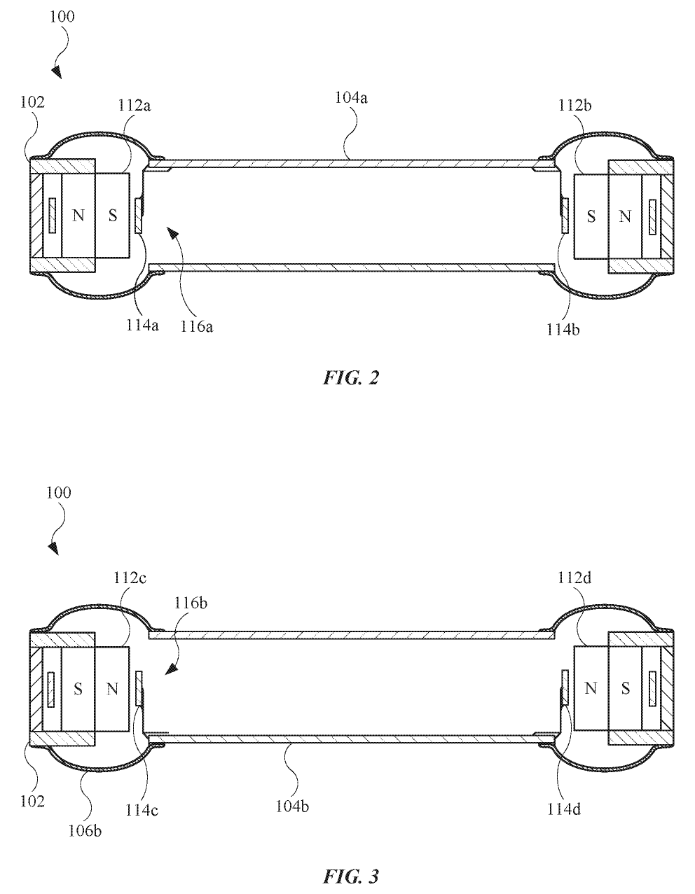

FIG. 2 illustrates a partial cross sectional view of the speaker 100 shown in FIG. 1, taken along line 2-2, showing additional features of the speaker, in accordance with aspects of the present disclosure. The speaker 100 may further include a magnet 112a and a magnet 112b. In one or more implementations, each of the magnets 112a and the 112b may take the form of a permanent magnet (e.g., rare Earth magnet). As shown, the magnet 112a is co-planar with respect to the magnet 112b, and vice versa. The speaker 100 may further include a voice coil 114a and a voice coil 114b disposed around the magnet 112a and the magnet 112b, respectively. As shown, the voice coils 114a and 114b are coupled (e.g., mechanically coupled) with the sound-generating component 104a.

The magnets 112a and 112b and the voice coils 114a and 114b may form a motor 116a of the speaker 100. During operation, each of the voice coils 114a and 114b may be provided with electrical current. In this regard, each of the voice coils 114a and 114b may form an electromagnet based on the electrical current. Moreover, based on the direction of the electrical current through the voice coils 114a and 114b, each of the voice coils 114a and 114b may form an electromagnet that is magnetically attracted to the magnets 112a and 112b, respectively, or magnetically repelled by the magnets 112a and 112b, respectively. As shown in FIG. 2, a magnetic pole (e.g., south pole) of the magnet 112a faces the voice coil 114a and a magnetic pole (e.g., south pole) of the magnet 112b faces the voice coil 114b. By providing electrical current in different directions through the voice coils 114a and 114b, the voice coils 114a and 114b may oscillate due to the magnetic attraction and repulsion, thereby causing the sound-generating component 104a to oscillate and generate an acoustic output. The surround 106a may permit relative movement of the sound-generating component 104a with respect to the housing 102.

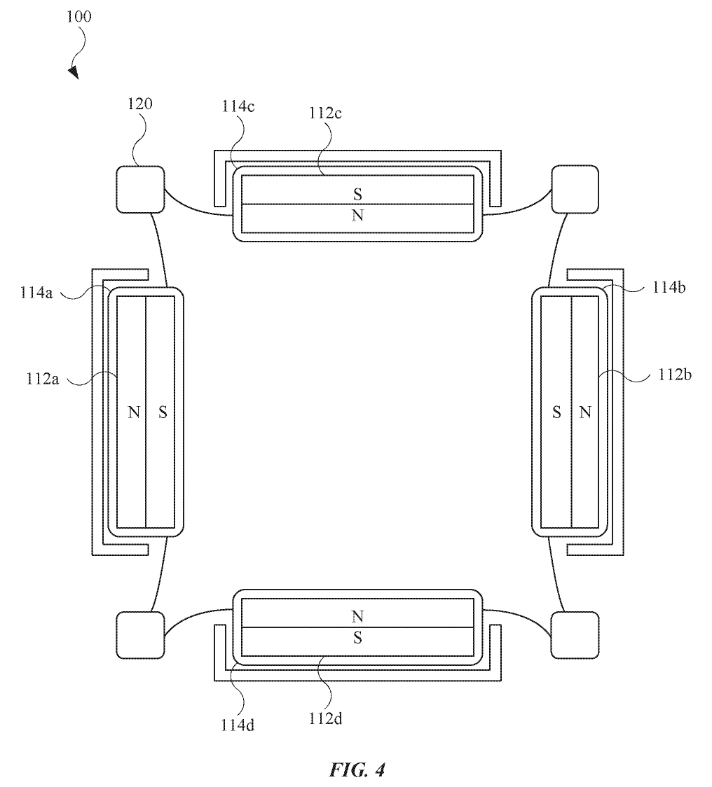

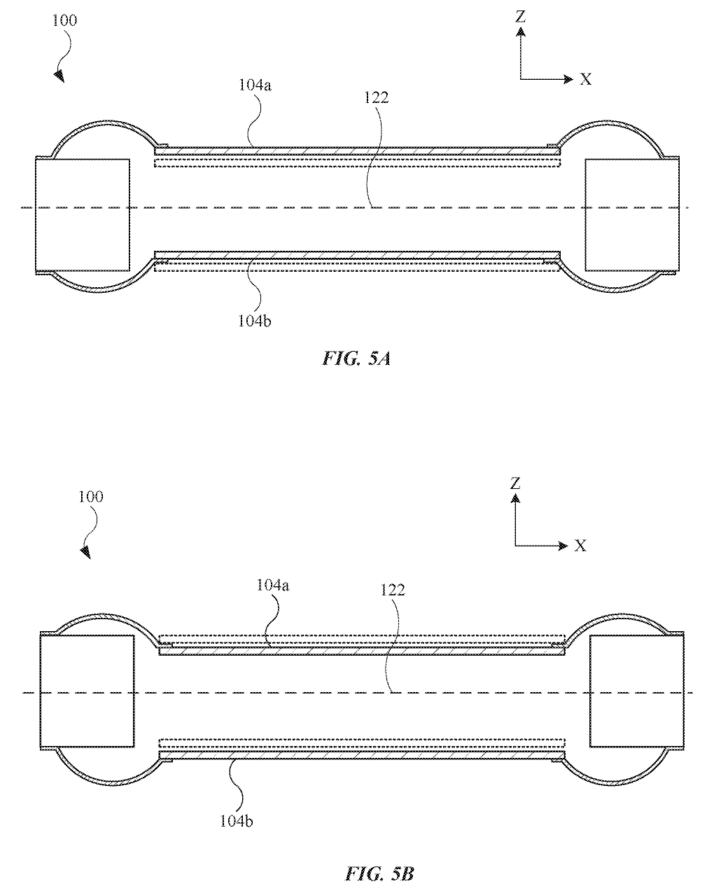

FIG. 3 illustrates a partial cross sectional view of the speaker shown in FIG. 1, taken along line 3-3, showing additional features of the speaker, in accordance with aspects of the present disclosure. The speaker 100 may further include a sound-generating component 104b and a surround 106b. The sound-generating component 104b and the surround 106b may include any features and characteristics shown and/or described for the sound-generating component 104a and the surround 106a (shown in FIGS. 1 and 2). The speaker 100 may further include a magnet 112c and a magnet 112d. Similar to the magnets 112a and 112b (shown in FIG. 2), each of the magnets 112c and the 112d may take the form of a permanent magnet (e.g., rare Earth magnet). As shown, the magnet 112c is co-planar with respect to the magnet 112d, and vice versa. The magnets 112c and 112d may be co-planar with respect to the magnets 112a and 112b (shown in FIG. 2). The speaker 100 may further include a voice coil 114c and a voice coil 114d disposed around the magnet 112c and the magnet 112d, respectively. As shown, the voice coils 114c and 114d are coupled (e.g., mechanically coupled) with the sound-generating component 104b.

The magnets 112c and 112d and the voice coils 114c and 114d may form a motor 116b of the speaker 100. Based on the motor 116a and the motor 116b (shown in FIGS. 2 and 3, respectively), the speaker 100 may be referred to as a dual motor speaker.

During operation, each of the voice coils 114c and 114d may be provided with electrical current. In this regard, each of the voice coils 114c and 114d may form an electromagnet based on the electrical current. Moreover, based on the direction of the electrical current through the voice coils 114c and 114d, each of the voice coils 114c and 114d may form an electromagnet that is magnetically attracted to the magnets 112c and 112d, respectively, or magnetically repelled by the magnets 112c and 112d, respectively. As shown in FIG. 3, a magnetic pole (e.g., north pole) of the magnet 112c faces the voice coil 114c and a magnetic pole (e.g., north pole) of the magnet 112d faces the voice coil 114d. In this regard, by providing electrical current in different directions through the voice coils 114c and 114d, the voice coils 114c and 114d may oscillate due to the magnetic attraction and repulsion, thereby causing the sound-generating component 104b to oscillate and generate an acoustic output.

Also, based on the magnetic poles of the magnets 112a and 112b facing the voice coils 114a and 114b (shown in FIG. 2), respectively, being different than the magnetic poles of the magnets 112c and 112d facing the voice coils 114c and 114d, respectively, electrical current in the same direction through the voice coils 114a, 114b, 114c, and 114d may cause the voice coils 114a, 114b, 114c, and 114d to react differently. For example, based on electrical current being provided in one direction, electromagnets formed by the voice coil 114a and 114b may be magnetically attracted to the magnets 112a and 112b, respectively, while electromagnets formed by the voice coil 114c and 114d may be magnetically repelled by the magnets 112c and 112d, respectively. As a result, the sound-generating components 104a and 104b may react differently. This will be shown and described in further detail below.

FIG. 4 illustrates an aerial view of the speaker 100, showing several components of the speaker 100, in accordance with aspects of the present disclosure. For the purposes of explanation, several components of the speaker 100 have been removed. The speaker 100 may include a wire 120 used to form each of the voice coils 114a, 114b, 114c, and 114d. Accordingly, the wire 120 may form the voice coils 114a and 114b for the motor 116a (shown in FIG. 2) and may further form the voice coils 114c and 114d for the motor 116b (shown in FIG. 3). In this regard, the wire 120 may represent a single wire used to form multiple voice coils. As a result, electrical current provided to the wire 120 may pass through each of the voice coils 114a, 114b, 114c, and 114d. Moreover, the electrical current may pass through the wire 120 and the voice coils 114a, 114b, 114c, and 114d in different directions (e.g., in the clockwise and counterclockwise directions). Based upon the orientation of the magnets 112a, 112b, 112c, and 112d and the direction of the electrical current, the respective electromagnets form by the voice coils 114a, 114b, 114c, and 114d may react differently, thus affecting the movement of the sound-generating components 104a and 104b (shown in FIGS. 2 and 3, respectively).

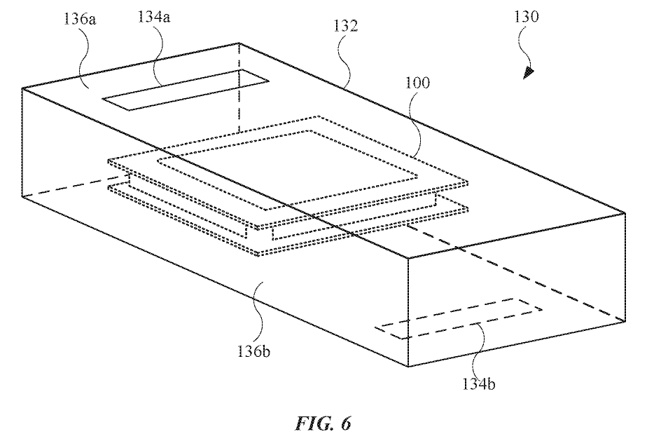

FIGS. 5A and 5B illustrate cross sectional views of the sound-generating components 104a and 104b of the speaker 100, showing exemplary movement of the sound generating components during operation, in accordance with aspects of the present disclosure. Each of the sound-generating components 104a and 104b may be driven to provide an acoustic output approximately in the range of 20 to 200 Hertz (Hz).

Referring to FIG. 5A, the electrical current may flow through the voice coils (e.g., voice coils, 114a, 114b, 114c, and 114d) in one direction. The motor 116a (shown in FIG. 2) may cause the sound-generate component 104a to move in a “forward” direction (e.g., away from a central axis 122 of the speaker 100). The dotted lines proximate to the sound-generating component 104a represent an original or initial position of the sound-generating component 104a. The movement of the sound-generating component 104a in the forward direction may be based on the voice coil 114a and the voice coil 114b (shown in FIG. 2) receiving an electrical current in one direction and forming respective electromagnets that are repelled by the magnet 112a and the magnet 112b, respectively (shown in FIG. 2).

However, the motor 116b (shown in FIG. 3) may cause the sound-generate component 104b to move in a “reverse” direction (e.g., toward from a central axis 122 of the speaker 100). The dotted lines proximate to the sound-generating component 104b represent an original or initial position of the sound-generating component 104b. The movement of the sound-generating component 104b in the reverse direction may be based on the voice coil 114c and the voice coil 114d (shown in FIG. 3) receiving an electrical current in one direction (e.g., the same direction as for the voice coils 114a and 114b shown in FIG. 2) and forming respective electromagnets that are attracted to the magnet 112c and the magnet 112d, respectively (shown in FIG. 3). Accordingly, both of the sound-generating components 104a and 104b may move in the same direction (e.g., along a positive direction of the Z axis).

Referring to FIG. 5B, the electrical current may flow through the voice coils (e.g., voice coils, 114a, 114b, 114c, and 114d) in another, opposite direction. The motor 116a (shown in FIG. 2) may cause the sound-generate component 104a to move in the reverse direction such that the sound-generating component 104a moves toward the central axis 122. The movement of the sound-generating component 104a in the reverse direction may be based on the voice coil 114a and the voice coil 114b (shown in FIG. 2) receiving an electrical current in the opposite direction and forming respective electromagnets that are attracted to the magnet 112a and the magnet 112b, respectively (shown in FIG. 2).

However, the motor 116b (shown in FIG. 3) may cause the sound-generate component 104b to move in the forward direction such that the sound-generate component 104b moves away from a central axis 122 of the speaker 100). The movement of the sound-generating component 104b in the forward direction may be based on the voice coil 114c and the voice coil 114d (shown in FIG. 3) receiving an electrical current in the opposite direction and forming respective electromagnets that are repelled by the magnet 112c and the magnet 112d, respectively (shown in FIG. 3). Accordingly, both of the sound-generating components 104a and 104b may also move in the same direction (e.g., along a negative direction of the Z axis).

Referring to FIG. 5A and 5B, the electrical current may be provided to the voice coils 114a, 114b, 114c, and 114d in both directions, thereby causing oscillation of the sound-generating components 104a and 104b, resulting in an acoustic output of each of the sound-generating components 104a and 104b. Based on the acoustic output, each of the sound-generating components 104a and 104b may generate energy based on audible vibrations (e.g., soundwaves) that propagate through the air. Due to the vibrations, each of the sound-generating components 104a and 104b may provide a force that causes movement of the speaker 100. However, based on one of the sound-generating components 104a and 104b moving in the forward direction while the other of the sound-generating components 104a and 104b moves in the reverse direction as described above, the respective forces from the sound-generating components 104a and 104b may cancel each other, thus minimizing distortion. In this regard, the speaker 100 may form a dipole speaker with two individual motors (e.g., motors 116a and 116b shown in FIGS. 2 and 3, respectively). Additionally, the speaker 100 with multiple sound-generating components (e.g., sound-generating components 104a and 104b are driven by respective motors (e.g., motor 116a shown in FIG. 2 and motor 116b shown in FIG. 3) in which several motor components (e.g., voice coils 114a, 114b, 114c, and 114d shown in FIGS. 2 or 3) of the respective motors are covered by respective sound-generating components. Based in part on the design layout of the speaker 100, additional space (e.g., along the Z axis) may be available to displace air when the sound-generating components 104a and 104b are in use.

Beneficially, the force-cancelling effect of the sound-generating components 104a and 104b mitigates or prevents unwanted movement of the speaker 100, which may provide for a better user experience.

While the terms “forward” and “reverse” are used to characterize movement of the sound-generating components 104a and 104b relative to the central axis 122, the sound-generating components 104a and 104b may nonetheless move in the same direction. For example, in FIG. 5A, the sound-generating components 104a and 104b move along the positive Z direction while in FIG. 5B, the sound-generating components 104a and 104b move along the negative Z direction.

FIG. 6 illustrates a perspective view of an assembly 130 with the speaker 100, in accordance with aspects of the present disclosure. The assembly 130 may include an enclosure 132 that provides a volume, or space, for the speaker 100. The enclosure 132 may include several ports, or openings. For example, the enclosure 132 may include a port 134a and a port 134b. As shown, the ports 134a and 134b are on different locations of the enclosure 132. For example, the enclosure 132 may include a wall 136a and a wall 136b through which the port 134a and the port 134b, respectively, are formed.

In one or more implementations, the wall 136a is parallel with respect to the wall 136b. As a result, the port 134a may be parallel with respect to the port 134b. Further, the walls 136a and 136b may be characterized as opposing walls (e.g., defining opposite sides of the enclosure 132). While the port 134a and the port 134b are formed from the wall 136a and the wall 136b, respectively, each of the ports 134a and 134b may be formed on any one or more of walls of the enclosure 132. Also, while a single port is shown as being formed through a single wall of the enclosure 132, any one or more of the walls of the enclosure 132 may include two or more ports.

Based on the location of the ports 134a and 134b (e.g., on walls of the enclosure 132), the ports 134a and 134b may be external to the speaker 100. Also, when the speaker 100 is driven to provide an acoustic output, the motor 116a (shown in FIG. 2) may drive the sound-generating component 104a (shown in FIG. 2) to generate an acoustic output through the port 134a while the motor 116b (shown in FIG. 3) may drive the sound-generating component 104b (shown in FIG. 3) to generate an acoustic output through the port 134b. Also, based on the location of the speaker 100 within the assembly 130, the speaker 100, including its components (e.g., motors 116a and 116b shown in FIGS. 2 and 3, respectively) may be positioned between the port 134a and the port 134b.

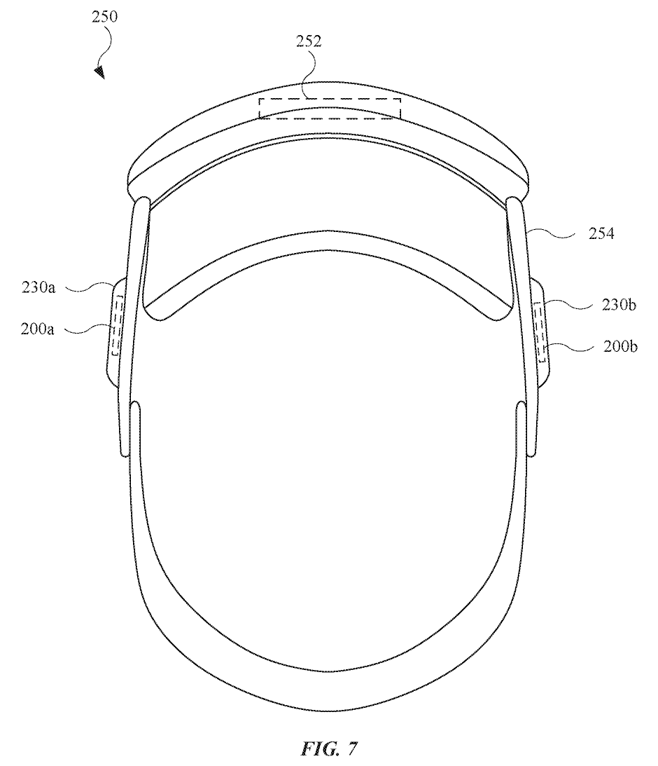

FIG. 7 illustrates an aerial view of an electronic device 250 with multiple speakers, in accordance with aspects of the present disclosure. In one or more implementations, the electronic device 250 takes the form of a wearable device. The electronic device 250 may take the form of a head mounted device, such as a mixed reality or a virtual reality device. In this regard, the electronic device 250 may include a display 252 representative of one or more displays. The electronic device 250 may further include a band 254 or arm, which may be representative of one or more bands or arms. As shown, the band 254 is coupled with the display 252.

The electronic device 250 may include at least one speaker. For example, the electronic device 250 may include a speaker 200a and a speaker 200b carried by the band 254. Each of the speaker 200a and the speaker 200b may include any component(s) and associated features as those of the speaker 100 (shown in FIGS. 1-6). As shown, the speaker 200a and the speaker 200b may be part of an assembly 230a and an assembly 230b, respectively. Each of the assembly 230a and the assembly 230b may include any component(s) and associated features as those of the assembly 130 (shown in FIG. 6). The band 254, taking the of one or more bands or arms, may be configured to hold the electronic device 250, including the display 252, the assembly 230a and the assembly 230b, on a user’s head.

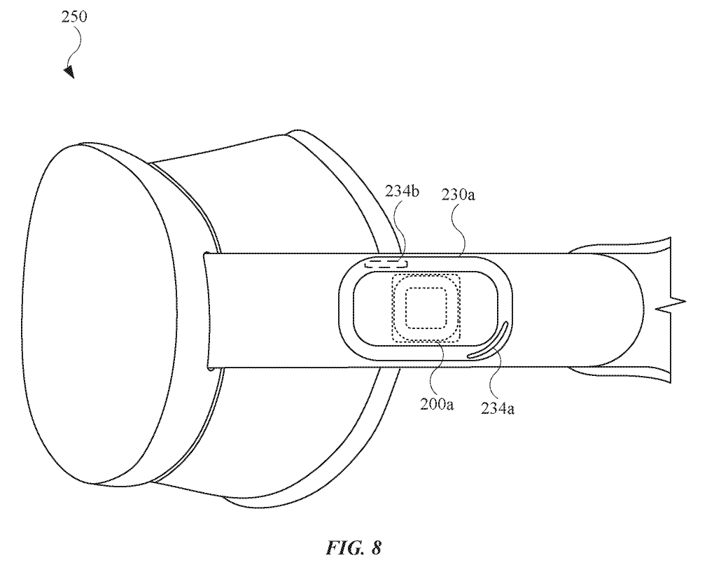

FIG. 8 illustrates a side view of electronic device 250 with a speaker 200a, in accordance with aspects of the present disclosure. As shown, the assembly 230a (representative of the assembly 230b shown in FIG. 7) may include a port 234a and a port 234b. The ports 234a and 234b may be formed in different walls of the assembly 230a including parallel or non-parallel walls.

When the electronic device 250 is worn by a user, the port 234a may face away from the user while the port 234b may face the user. In this regard, the port 234a and the port 234b may be characterized as a front port and a rear port, respectively.

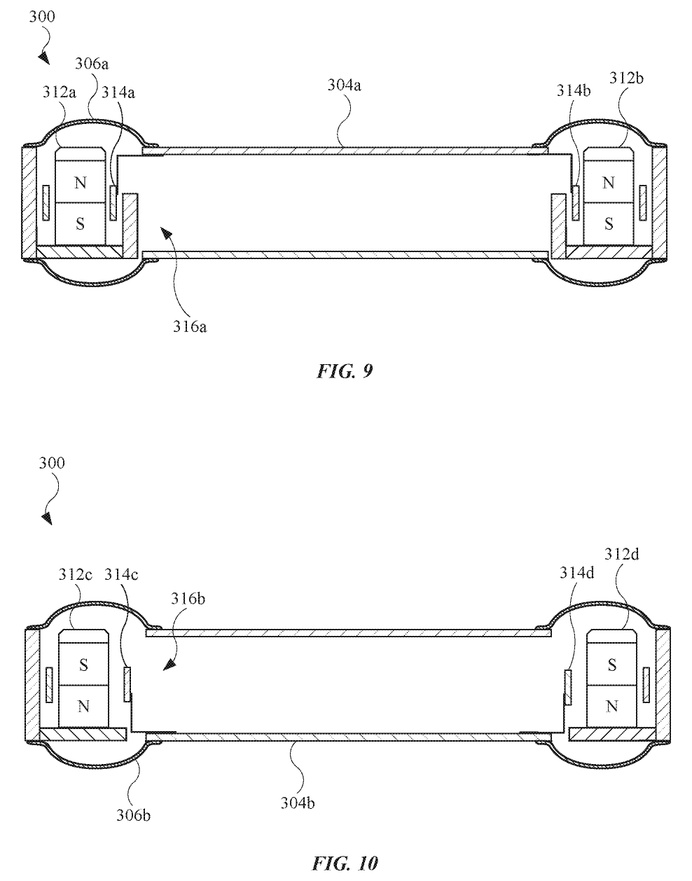

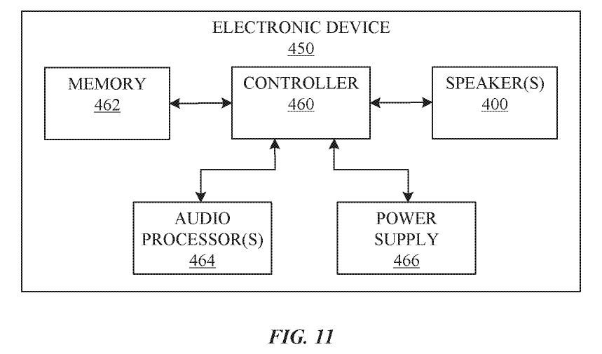

FIGS. 9 and 10 illustrate partial cross sectional views of a speaker 300, showing additional orientations of magnets of the speaker 300, in accordance with aspects of the present disclosure. The speaker 300 may function in a similar manner shown and/or described for other speakers (e.g., speaker 100 shown in FIG. 1). Referring to FIG. 9, the speaker 300 may include a magnet 312a and a magnet 312b. In one or more implementations, each of the magnets 312a and the 312b may take the form of a permanent magnet (e.g., rare Earth magnet). As shown, the magnet 312a is co-planar with respect to the magnet 312b, and vice versa. Also, the magnets 312a and 312b may be oriented in a different manner than the magnets 112a and 112b (shown in FIG. 3). For example, the magnets 312a and 312b are rotated 90 degrees such that the poles (e.g., north and south poles) are vertically arranged. The speaker 300 may further include a voice coil 314a and a voice coil 314b disposed around the magnet 312a and the magnet 312b, respectively. As shown, the voice coils 314a and 314b are coupled (e.g., mechanically coupled) with the sound-generating component 304a of the speaker 300, with the sound-generating component 304a connected to a surround 306a of the speaker 300.

The magnets 312a and 312b and the voice coils 314a and 314b may form a motor 316a of the speaker 300. During operation, each of the voice coils 314a and 314b may be provided with electrical current. Accordingly, the motor 316a may operate similar to a manner previously described for motors.

Referring to FIG. 10, the speaker 300 may further include a sound-generating component 304b and a surround 306b. The speaker 300 may further include a magnet 312c and a magnet 312d. Similar to the magnets 312a and 312b (shown in FIG. 3), each of the magnets 312c and the 312d may take the form of a permanent magnet (e.g., rare Earth magnet). As shown, the magnet 312c is co-planar with respect to the magnet 312d, and vice versa. The magnets 312c and 312d may be co-planar with respect to the magnets 312a and 312b (shown in FIG. 3). Also, the magnets 312c and 312d may be oriented in a different manner than the magnets 112c and 112d (shown in FIG. 3). For example, the magnets 312c and 312d are rotated 90 degrees such that the poles (e.g., north and south poles) are vertically arranged. The speaker 300 may further include a voice coil 314c and a voice coil 314d disposed around the magnet 312c and the magnet 312d, respectively. As shown, the voice coils 314c and 314d are coupled (e.g., mechanically coupled) with the sound-generating component 304b.

The magnets 312c and 312d and the voice coils 314c and 314d may form a motor 316b of the speaker 300. During operation, each of the voice coils 314c and 314d may be provided with electrical current. Accordingly, the motor 316b may operate similar to a manner previously described for motors. Based on the motor 316a and the motor 316b (shown in FIGS. 9 and 10, respectively), the speaker 300 may be referred to as a dual motor speaker.

FIG. 11 illustrates a block diagram of an electronic device 450, in accordance with aspects of the present disclosure. In one or more embodiments, the electronic device 450 is representative of prior systems shown and/or described herein. In one or more embodiments, electronic device 450 includes a controller 460 designed to monitor components and/or provide commands to other components. For example, the controller 460 may include one or more processors, such as a central processing unit, a graphics processing unit, a microelectromechanical systems (MEMS) controller, and/or one or more microcontrollers. In one or more embodiments, the controller 460 is communicatively coupled (e.g., in communication with), and configured to provide commands to, various components of electronic device 450.

The electronic device 450 may further include memory 462 that stores instructions (e.g., executable instructions) for the controller 460. For example, the electronic device 450 may include one or more speakers 400 designed to provide an acoustic output. Each of the one or more speakers 400 may include any components and associated features as those of the speaker 100 (shown in FIGS. 1-6) or the speakers 200a and 200b (shown in FIGS. 7-8).

The electronic device 450 may further include one or more audio processors 464. The controller 460 may utilize the one or more audio processors 464 may generate audio signals provided to a wire (e.g., wire 120 shown in FIG. 4) to drive the one or more speakers 400 to generate an acoustic output. The electronic device 450 may further include a power supply 466 (e.g., battery) that provides power to the controller 460. The controller 460 may receive electrical current from the power supply 466 and provide the electrical current to the one or more speakers 400, thereby causing the one or more speakers 400 to provide an acoustic output in accordance with a manner shown and/or described herein.

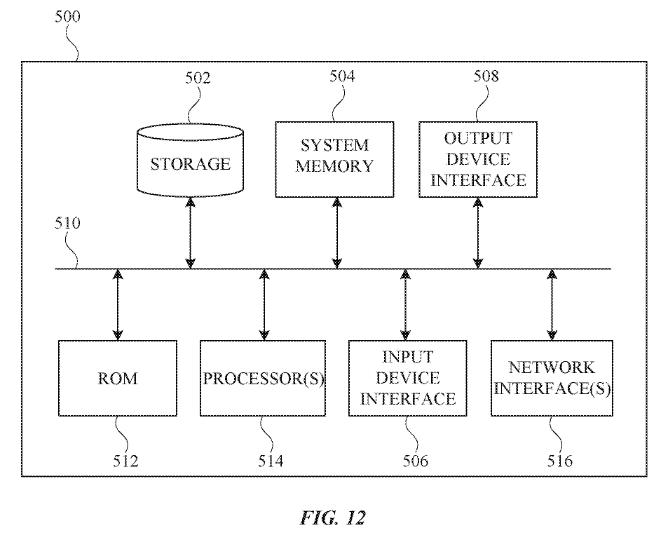

FIG. 12 illustrates an electronic system 500 with which one or more implementations of the subject technology may be implemented. The electronic system 500 can be, and/or can be a part of, the electronic device 250 shown in FIGS. 7-8 or the electronic device 450 shown in FIG. 11. The electronic system 500 may include various types of computer readable media and interfaces for various other types of computer readable media. The electronic system 500 includes a bus 510, one or more processing units 514, a system memory 504 (and/or buffer), a ROM 512, a permanent storage device 502, an input device interface 506, an output device interface 508, and one or more network interfaces 516, or subsets and variations thereof.

The bus 510 collectively represents all system, peripheral, and chipset buses that communicatively connect the numerous internal devices of the electronic system 500. In one or more implementations, the bus 510 communicatively connects the one or more processing units 514 with the ROM 512, the system memory 504, and the permanent storage device 502. From these various memory units, the one or more processing units 514 retrieves instructions to execute and data to process in order to execute the processes of the subject disclosure. The one or more processing units 514 can be a single processor or a multi-core processor in different implementations.

The ROM 512 stores static data and instructions that are needed by the one or more processing units 514 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing units 514 may need at runtime. In one or more implementations, the processes of the subject disclosure are stored in the system memory 504, the permanent storage device 502, and/or the ROM 512 (which are each implemented as a non-transitory computer-readable medium). From these various memory units, the one or more processing units 514 retrieves instructions to execute and data to process in order to execute the processes of one or more implementations.

The bus 510 also connects to the input device interface 506 and output device interface 508. The input device interface 506 enables a user to communicate information and select commands to the electronic system 500. Input devices that may be used with the input device interface 506 may include, for example, alphanumeric keyboards and pointing devices (also called “cursor control devices”). The input device interface 506 may enable, for example, the display of images generated by electronic system 500. Output devices that may be used with the input device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 510 also couples the electronic system 500 to one or more networks and/or to one or more network nodes through the one or more network interfaces 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being "connected" or "coupled" to another element, it is to be understood that the elements can be directly connected to the other element, or have intervening elements present between the elements. In contrast, when an element is referred to as being "directly connected" or "directly coupled" to another element, it should be understood that no intervening elements are present in the "direct" connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A speaker, comprising:
a first sound-generating component;
a first magnet;
a second sound-generating component;
a second magnet; and
a wire that forms a first voice coil and a second voice coil, wherein:
the first voice coil is configured to drive the first sound-generating component based on the first magnet, and
the second voice coil is configured to drive the second sound-generating component based on the second magnet.

2. The speaker of claim 1, wherein:
the first voice coil is disposed around the first magnet, and
the second voice coil is disposed around the second magnet.

3. The speaker of claim 2, further comprising:
a third magnet; and
a fourth magnet, wherein:
the first voice coil is configured to drive the first sound-generating component based on the third magnet, and
the second voice coil is configured to drive the second sound-generating component based on the fourth magnet.

4. The speaker of claim 3, wherein:
the first magnet is co-planar with respect to the second magnet, and
the third magnet is co-planar with respect to the fourth magnet.

5. The speaker of claim 4, wherein the first magnet is co-planar with respect to the third magnet.

6. The speaker of claim 1, further comprising a housing, wherein the first sound-generating component, the first magnet, the second sound-generating component, the second magnet, and the wire are disposed in the housing.

7. The speaker of claim 1, wherein:
the first sound-generating component comprises a first diaphragm, and
the second sound-generating component comprises a second diaphragm parallel with respect to the first diaphragm.

8. The speaker of claim 7, wherein in response to the first diaphragm driven in a first direction, the second diaphragm is configured to be driven in the first direction.

9. The speaker of claim 1, wherein:
a first magnetic pole of the first magnet faces toward the first voice coil,
a second magnetic pole of the second magnet faces toward the second voice coil, and
the second magnetic pole is opposite the first magnetic pole.

10. A speaker, comprising:
a housing;
a first motor disposed in the housing, the first motor configured to drive a first sound-generating component, the first motor comprising a first magnet;
a second motor disposed in the housing, the second motor configured to drive a second sound-generating component, the second motor comprising a second magnet; and
a wire that forms i) a first voice coil disposed around the first magnet and ii) a second voice coil disposed around the second magnet, wherein the first voice coil and the second voice coil are configured to receive an applied electrical current via the wire.

11. The speaker of claim 10, further comprising:
a third magnet; and
a fourth magnet, wherein the wire further forms:
a third voice coil disposed around the third magnet, and
a fourth voice coil disposed around the fourth magnet.

12. The speaker of claim 11, wherein the third voice coil and the fourth voice coil receive are configured to receive the applied electrical current via the wire.

13. The speaker of claim 11, wherein in response to the first sound-generating component driven in a direction by the first voice coil and the third voice coil, the second sound-generating component is configured to be driven in the direction by the second voice coil and the fourth voice coil.

14. The speaker of claim 11, the first magnet is co-planar with respect to the second magnet, the third magnet, and the fourth magnet.

15. The speaker of claim 10, wherein:
a first magnetic pole of the first magnet faces toward the first voice coil,
a second magnetic pole of the second magnet faces toward the second voice coil, and
the second magnetic pole is opposite the first magnetic pole.

16. A wearable device, comprising:
one or more arms or bands configured to hold the wearable device in place on a user’s head; and
at least one assembly carried by the one or more arms or bands, the at least one assembly comprising:
a speaker that includes:
a first motor,
a second motor,
a wire that forms i) a first voice coil for the first motor and ii) a second voice coil for the second motor, wherein the first voice coil and the second voice coil are configured to receive an applied electrical current via the wire;
a first port, wherein the first motor is configured to drive a first sound-generating component, via the first voice coil, to generate a first acoustical output through the first port; and
a second port, wherein the second motor is configured to drive a second sound-generating component, via the second voice coil, to generate a second acoustical output through the second port.

17. The wearable device of claim 16, wherein the at least one assembly comprises:
a first wall, wherein the first port is formed through the first wall; and
a second wall, wherein the second port is formed through the second wall.

18. The wearable device of claim 16, wherein:
the first motor comprises a first magnet,
the second motor comprises a second magnet co-planar with respect to the first magnet,
the first voice coil is disposed around the first magnet, and
the second voice coil is disposed around the second magnet.

19. The wearable device of claim 16, wherein the speaker is positioned between the first port and the second port.

20. The wearable device of claim 16, wherein in response to the first sound-generating component driven in a direction, the second sound-generating component is configured to be driven in the direction.
